(19) United States
(12) Patent Application Publication
(10) Pub. No.: US 2022/0111650 A1
(43) Pub. Date: Apr. 14, 2022

(54) RECORDING APPARATUS AND RETAINING CONTAINER

(71) Applicant: CANON KABUSHIKI KAISHA, Tokyo (JP)

(72) Inventors: Yusuke Tanaka, Kanagawa (JP); Koya Iwakura, Kanagawa (JP); Hideaki Matsumura, Kanagawa (JP); Tetsu Hamano, Tokyo (JP); Nobuhiro Toki, Kanagawa (JP); Daiju Takeda, Kanagawa (JP); Fumie Kameyama, Tokyo (JP); Koki Shimada, Kanagawa (JP); Shota Asada, Tokyo (JP); Ken Takenaga, Kanagawa (JP); Yuta Araki, Chiba (JP); Taiji Maruyama, Kanagawa (JP); Atsushi Matsuyama, Kanagawa (JP); Yusuke Naratani, Tokyo (JP); Kousuke Tanaka, Kanagawa (JP)

(21) Appl. No.: 17/492,452

(22) Filed: Oct. 1, 2021

(30) Foreign Application Priority Data
Oct. 9, 2020 (JP) 2020-170871

(51) Int. Cl. B41J 2/165

(52) U.S. Cl. CPC B41J 2/16517

(57) ABSTRACT

A recording apparatus includes a recovery unit, a retaining container, and a first portion. The recovery unit performs recovery operation to recover a recording head to eject liquid. The retaining container is removably installed in the recording apparatus and retains liquid discharged from the recovery unit. The first portion comes in contact with a second portion on the retaining container. To put the retaining container into a restricted state in which movement of the retaining container in a first direction is restricted, the first portion comes in contact with the second portion in a middle of removal of the retaining container in the first direction from an installed state in which the retaining container is installed in the recording apparatus.

### BACKGROUND

### Field

The present disclosure relates to recording apparatuses recording images, and to a retaining container used in a recording apparatus.

### Description of the Related Art

An inkjet recording apparatus performs a recovery operation including suction of ink to maintain discharge performance of the recording head. Some inkjet recording apparatuses include a replaceable waste ink tank to contain and retain waste ink produced by the recovery operation.

Japanese Patent Application Laid-Open No. 11-334110 discusses an inkjet recording apparatus having a configuration in which, when a user removes the waste ink tank, the waste-ink temporarily receiving mechanism to receive ink dripping from an ink tube is moved under the ink tube. This configuration prevents waste ink from leaking to the outside of the apparatus as the waste-ink temporarily receiving mechanism receives waste ink in the removal of the waste ink tank during a recovery operation. The configuration discussed in Japanese Patent Application Laid-Open No. H11-334110, however, entails including a separate waste-ink temporarily receiving mechanism and an area for the mechanism to move in the apparatus for easy removal of the waste ink tank by a user, which can cause upsizing and complication of the apparatus.

### SUMMARY

The present disclosure is directed to a recording apparatus that restricts operation of removing a retaining container.

According to an aspect of the present disclosure, a recording apparatus includes a recovery unit configured to perform recovery operation to recover a recording head to eject liquid, a retaining container configured to be removably installed in the recording apparatus and to retain liquid discharged from the recovery unit, and a first portion configured to come in contact with a second portion on the retaining container, wherein, to put the retaining container into a restricted state in which movement of the retaining container in a first direction is restricted, the first portion comes in contact with the second portion in a middle of removal of the retaining container in the first direction from an installed state in which the retaining container is installed in the recording apparatus.

Further features of the present disclosure will become apparent from the following description of exemplary embodiments with reference to the attached drawings.

### BRIEF DESCRIPTION OF THE DRAWINGS

FIG. 1 is a perspective view illustrating an internal configuration of an inkjet recording apparatus according to a first exemplary embodiment.

FIG. 2 is a block diagram illustrating a control system of the inkjet recording apparatus according to the first exemplary embodiment.

FIG. 3 is a perspective view illustrating a recovery unit according to the first exemplary embodiment.

FIGS. 4A and 4B are diagrams each illustrating a configuration of a waste ink tank according to the first exemplary embodiment.

FIGS. 5A to 5D are schematic cross-sectional views illustrating an operation of removing the waste ink tank according to the first exemplary embodiment.

FIG. 6 is a flowchart illustrating an operation when the waste ink tank is removed during a recovery operation according to the first exemplary embodiment.

FIGS. 7A and 7B are schematic cross-sectional views illustrating an operation of removing a waste ink tank according to a second exemplary embodiment.

### DESCRIPTION OF THE EMBODIMENTS

Some exemplary embodiments of the present disclosure will be described below with reference to drawings. The following exemplary embodiments do not intend to limit the present disclosure, and not all of the combinations of features described in the exemplary embodiments are used in the solution of the present disclosure. Further, relative arrangement, shapes, etc. of components described in the exemplary embodiments are merely illustrative, and do not intend to limit the scope of the present disclosure.

### <Apparatus Configuration>

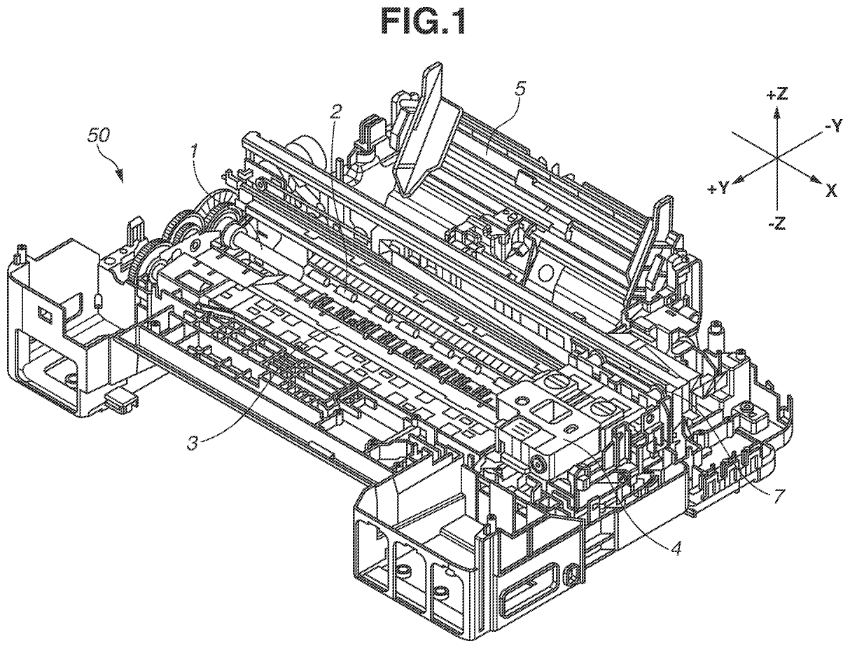

FIG. 1 is a perspective view illustrating an internal configuration of an inkjet recording apparatus (hereinafter, recording apparatus) 50 according to a first exemplary embodiment. The recording apparatus 50 includes a recording head 4 that performs recording operation to record images by ejecting ink to recording media. The recording apparatus 50 includes a cover (not illustrated) openable/closable for a housing, and FIG. 1 illustrates the configuration with the cover opened. The cover may include a scanner unit that can read documents.

In the recording apparatus 50, recording media placed on a sheet feeding tray 5 at the back side are separated one by one, and are fed by a sheet feeding roller (not illustrated) serving as a feeding unit. Each recording medium fed by the feeding roller is conveyed to a recording position facing a recording head 4 by a conveyance roller 1 serving as a conveyance unit and a pinch roller 2 driven by the conveyance roller 1.

The recording apparatus 50 further includes a platen 3 at a position facing the recording head 4. The back surface of the recording medium conveyed to the recording position is supported by the platen 3. The recording head 4 performs recording on the recording medium based on data at the recording position. The recording medium that has undergone the recording performed by the recording head 4 is discharged by a discharge roller (not illustrated) to the outside of the recording apparatus 50.

In the present exemplary embodiment, the direction (+Y direction illustrated in FIG. 1) in which the recording medium is conveyed by the conveyance unit is referred to as a conveyance direction. In other words, the back side of the recording apparatus 50 lies upstream in the conveyance direction; the front side lies downstream. Further, the upside of the gravitational direction lies in the Z direction.

The recording head 4 is mounted to a carriage 7 that reciprocates in the main scanning direction (X direction illustrated in FIG. 1) intersecting the conveyance direction. In the present exemplary embodiment, the conveyance direction (+Y direction) and the main scanning direction (X direction) are orthogonal to each other. The recording head 4 ejects ink droplets while being moved with the carriage 7 in the main scanning direction, thereby recording an image with a predetermined length (one band) on the recording medium (recording operation). After the one band image is recorded, the recording medium is conveyed by a predetermined amount by the conveyance roller 1 and the pinch roller 2 (intermittent conveyance operation). The recording operation by one band and the intermittent conveyance operation are repeated to record the whole image on the entire recording medium based on image data.

Further, the recording head 4 according to the present exemplary embodiment includes a unit (e.g., heating resistance element) generating heat energy as energy used for ink ejection, and uses a system causing a state change of the ink (film boiling) by the heat energy. This achieves high density and high definition of image recording. The recording head of the present exemplary embodiment is not limited to the system using heat energy, and may include a piezoelectric element to use vibrational energy.

In the present exemplary embodiment, an example of a serial head in which the recording head 4 is mounted to the carriage 7 is described; however, the recording head of the present exemplary embodiment is not limited thereto and a line head in which a plurality of ejection ports is arranged in the area corresponding to the width of the recording medium can be used.

Further, ink may be supplied to the recording head 4 through a tube supply system in which ink is supplied from an ink tank fixed to the recording apparatus 50 through a tube or the like, or through an on-carriage system in which ink is supplied from an ink tank mounted to the carriage 7 together with the recording head 4. Further, as a tube supply system, a system may be used in which a user injects ink from an ink replenishment container such as an ink bottle to an ink tank.

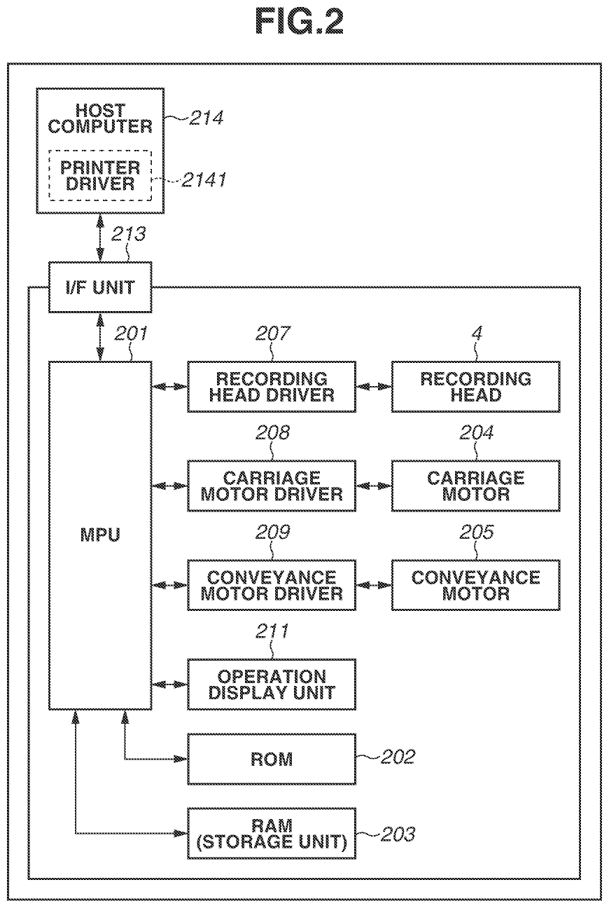

FIG. 2 is a block diagram illustrating a control system of the recording apparatus 50. A microprocessor unit (MPU) 201 performs the general control of the recording apparatus 50, such as the operation of each unit and data processing. A read only memory (ROM) 202 stores programs to be run by the MPU 201 and various kinds of data. A random access memory (RAM) 203 temporarily stores data to be processed by the MPU 201 and data received from a host computer 214.

The recording head 4 is controlled by a recording head driver 207. A carriage motor 204 to drive the carriage 7 is controlled by a carriage motor driver 208. The conveyance roller 1 and the discharge roller are driven by a conveyance motor 205. The conveyance motor 205 is controlled by a conveyance motor driver 209.

The host computer 214 includes a printer driver 2141. In response to an instruction of recording operation issued by a user, the printer driver 2141 collects an image to be recorded and recording information such as image quality, and communicates with the recording apparatus 50. The MPU 201 sends or receives the image to be recorded and other information to or from the host computer 214 through an interface (I/F) unit 213. The recording apparatus 50 further includes an operation display unit 211 on which the user can perform operations such as an instruction input to the recording apparatus 50. The operation display unit 211 can show notifications to the user by displaying an error that has occurred or other information on the recording apparatus 50 or other messages.

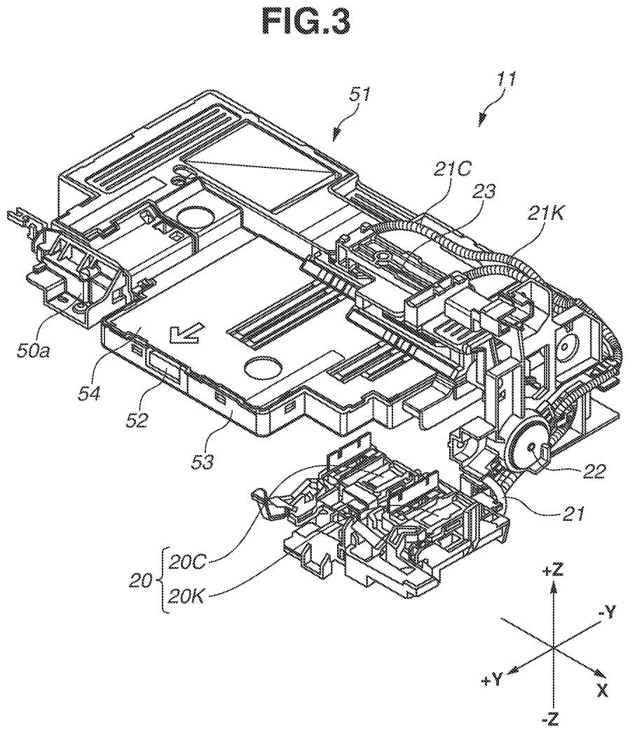

FIG. 3 is a perspective view illustrating a recovery unit 11 in the recording apparatus 50. The recovery unit 11 is a unit to perform recovery operation to maintain ejection performance of the recording head 4. The recovery unit 11 includes a cap 20 capping ejection ports (not illustrated) of the recording head 4 in which the ejection ports to eject ink are provided. The recording head 4 according to the present exemplary embodiment includes two types of recording heads, namely, a black recording head to eject black ink and a color recording head to eject color ink, and the black recording head and the color recording head have ejection ports. Thus, the cap 20 includes a black cap 20K for the black recording head and a color cap 20C for the color recording head. In the following, the two caps are collectively referred to as the cap 20.

The recovery unit 11 further includes a suction tube 21 connected to the cap 20, a suction pump 22 to suction ink from the recording head 4 through the suction tube 21, and a waste ink tank 51 as an ink retaining container that retains the suctioned waste ink. The suction tube 21 includes a black suction tube 21K connected to the black cap 20K, and a color suction tube 21C connected to the color cap 20C. The suction tubes 21K and 21C are both connected to a flow channel member 23, and the flow channel member 23 takes the waste ink in the openings (described below) of the waste ink tank 51.

The recovery operation on the recording head 4 includes suction operation to drive the suction pump 22 to suction ink from the ejection ports with the ejection ports tightly capped by the cap 20. This suction operation forces air bubbles and sticky ink in the ejection ports to be suctioned and discharged out.

The recovery operation further includes preliminary ejection operation in which ink not used for recording operation is ejected from the recording head 4 with the recording head 4 facing the cap 20. The recording head 4 according to the present exemplary embodiment performs preliminary ejection to the cap 20; however, the recording head 4 may perform preliminary ejection to an ink receiving portion different from the cap 20. Preliminary ejection operation forces sticky ink in the ejection ports to be discharged out. The ink preliminarily ejected to the cap 20 is discharged to the waste ink tank 51 by driving of the suction pump 22.

The waste ink tank 51 according to the present exemplary embodiment functions as an ink retaining container removably installed to the recording apparatus 50. The user installs the waste ink tank 51 in the recording apparatus 50 in the +Y direction, and removes the waste ink tank 51 from the recording apparatus 50 in the −Y direction. The waste ink tank 51 according to the present exemplary embodiment will be described in detail below.

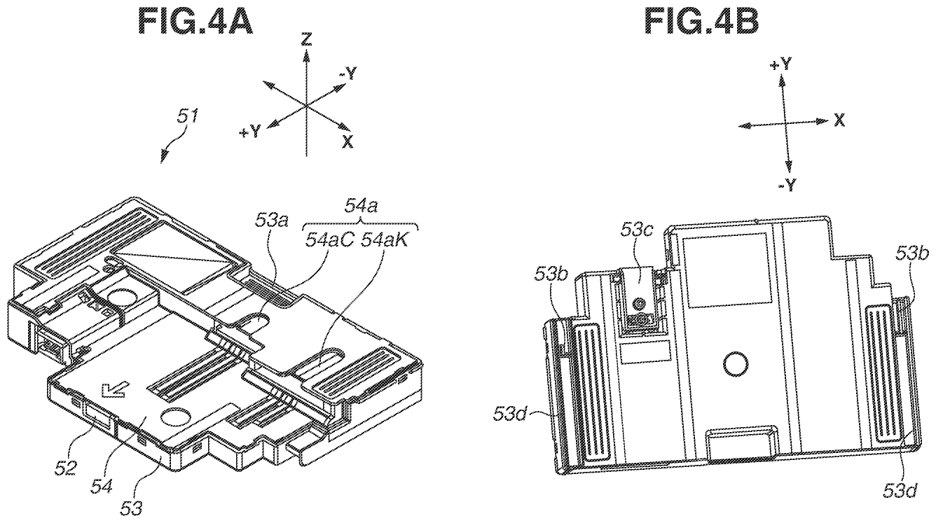

FIGS. 4A and 4B are detailed diagrams each illustrating the waste ink tank 51 according to the present exemplary embodiment. FIG. 4A is a top perspective view of the waste ink tank 51, and FIG. 4B is a bottom view of the waste ink tank 51. The waste ink tank 51 includes an absorber 52 that absorbs and retains waste ink, a substantially box-shaped container portion 53 that has an openable upper portion and houses the absorber 52, and a lid portion 54 attached covering an opening of the container portion 53.

The top surface, or the lid portion 54 of the waste ink tank 51 includes waste ink take-in portion (opening portion) 54a to take waste ink from the flow channel member 23 into the container portion 53. The waste ink take-in portion 54a includes a black ink take-in portion 54aK to take in waste ink discharged from the black suction tube 21K, and a color ink take-in portion 54aC to take in waste ink discharged from the color suction tube 21C. The black ink take-in portion 54aK and the color ink take-in portion 54aC are separated from each other.

Waste ink suctioned by the suction pump 22 is taken from the flow channel member 23 into the inside of the waste ink tank 51 through the waste ink take-in portion 54a, and is absorbed and retained in the absorber 52. When the total amount of waste ink measured by a waste ink counter included in the control unit (MPU 201) of the recording apparatus 50 exceeds a predetermined amount, the user is urged to replace the waste ink tank 51 through display on the operation display unit 211, etc. The user takes out the waste ink tank 51 filled up with waste ink from the recording apparatus 50, and installs a new waste ink tank in place of the waste ink tank 51. The waste ink counter counts the amount of waste ink discharged to the waste ink tank 51 through the suction operation and the preliminary ejection operation performed as recovery operation.

The container portion 53 includes an operation portion 53a (see FIG. 4A) in the top surface. The operation portion 53a is operable by the user in installation and removal of the waste ink tank 51 to and from the recording apparatus 50. Further, the container portion 53 includes an engagement portions 53b (see FIG. 4B) on the bottom surface. The engagement portions 53b are engaged with the recording apparatus 50 in the middle of the removal of the waste ink tank 51. Two engagement portions 53b each are provided at either end in the X direction, protruding downward from the bottom surface of the container portion 53 (waste ink tank 51). However, the number of engagement portions 53b is not limited to two.

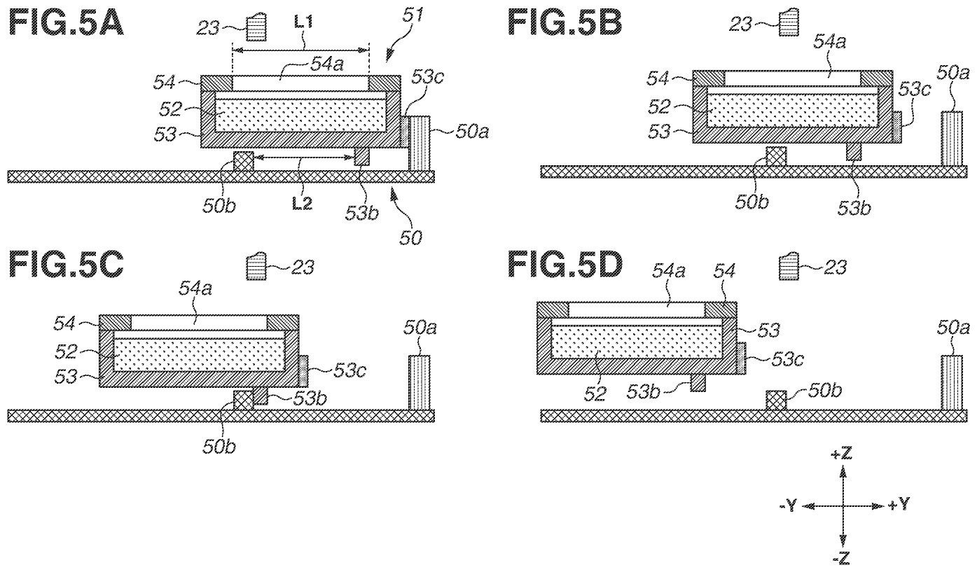

The recording apparatus 50 includes a detection unit 50a (see FIG. 3 and FIGS. 5A to 5D) to detect whether the waste ink tank 51 is installed in place. The container portion 53 includes a detected portion 53c to be detected by the detection unit 50a. The detection unit 50a detects the waste ink tank 51 installed in place with the detection unit 50a in contact with the detected portion 53c; otherwise, the detection unit 50a detects the waste ink tank 51 out of place with the detection unit 50a out of contact with the detected portion 53c (in a not-installed state).

The recording apparatus 50 controls driving of the suction pump 22 based on the result of detection by the detection unit 50a. More specifically, if the detection unit 50a detects the waste ink tank 51 installed in place, the recording apparatus 50 can drive the suction pump 22. Otherwise, if the detection unit 50a detects the waste ink tank 51 not installed in place, the recording apparatus 50 stops driving of the suction pump 22.

Further, as illustrated in FIG. 4B, two positioning surfaces 53d both ends of the container portion 53 in the X direction are used to position the waste ink tank 51 in the X direction with respect to the recording apparatus 50. The positioning surfaces 53d face each other in the X direction. The waste ink tank 51 installed therein is positioned in contact with the guides extending in the Y direction on the bottom of the housing of the recording apparatus 50. This configuration prevents abnormal wear (galling) of the container portion 53 and provides an easier installation operation by a user as compared with the case where the positioning surfaces 53d are provided on the outer edge surface of the container portion 53.

In the present exemplary embodiment, the configuration including the two positioning surfaces 53d has been described; however, the number of positioning surfaces 53d is not limited thereto. If the surfaces faces the center of the waste ink tank 51 in the X direction are the positioning surfaces 53d, wear of the outer edge surface of the container portion 53 can be reduced.

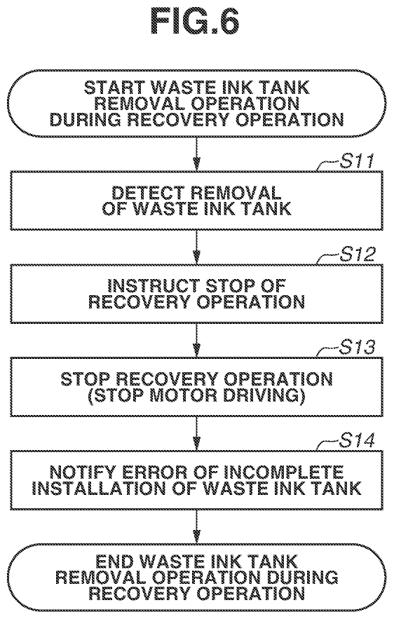

FIGS. 5A to 5D are schematic cross-sectional views illustrating operation of removing the waste ink tank 51 according to the present exemplary embodiment. FIG. 6 is a flowchart illustrating operation of the recording apparatus 50 when the waste ink tank 51 is removed during recovery operation.

FIG. 5A illustrates the waste ink tank 51 installed in the recording apparatus 50. In this state, the waste ink take-in portion 54a is positioned below (just below) the flow channel member 23. Further, the detection unit 50a and the detected portion 53c is in contact with each other, allowing the recording apparatus 50 to operate the suction pump 22. In recovery operation, the recording apparatus 50 drives the suction pump 22. Waste ink discharged from the flow channel member 23 in the recovery operation is taken in the inside of the waste ink tank 51 through the waste ink take-in portion 54a just below the flow channel member 23.

FIGS. 5B to 5D are diagrams each illustrating a state in the operation of removing the waste ink tank 51 performed by the user in order. As illustrated in FIG. 5B, the waste ink tank 51 starts moving in the −Y direction by the removal operation by the user.

The operation in FIG. 6 will be described with reference to FIGS. 5A to 5D. In the state illustrated in FIG. 5B during the recovery operation, the detected portion 53c is separated from the detection unit 50a, and, in step S11, the MPU 201 detects the waste ink tank 51 in the not-installed state. Just after the removal operation by the user starts, the waste ink take-in portion 54a is just below the flow channel member 23 as illustrated in FIG. 5B, waste ink, if discharged from the flow channel member 23, falls in the waste ink take-in portion 54a. This prevents waste ink from leaking to the outside of the waste ink tank 51.

In step S12, the MPU 201 issues an instruction to stop driving of the suction pump 22 (recovery operation). In step S13, driving of the suction pump 22 is stopped by stop of the motor driving the suction pump 22. In step S14, the MPU 201 notifies the user that the waste ink tank 51 is in the not-installed state. More specifically, the MPU 201 may display an error on the operation display unit 211, or may perform notification to the user through the host computer 214.

If the removal operation of the waste ink tank 51 by the user is continued in parallel with the above-described operation, the engagement portions 53b of the waste ink tank 51 and engagement portions 50b of the recording apparatus 50 engage with each other as illustrated in FIG. 5C. As a result, the movement of the waste ink tank 51 is temporarily restricted in the −Y direction. Even in the restricted state, the waste ink take-in portion 54a is just below the flow channel member 23. This allows waste ink discharged from the flow channel member 23 to fall in the waste ink take-in portion 54a, preventing the ink from leaking to the outside of the waste ink tank 51 and the outside of the recording apparatus 50.

The user can release the engagement between the engagement portions 53b and the engagement portions 50b by lifting the waste ink tank 51 in the restricted state upward (+Z direction), and continue the removal operation in the −Y direction again. FIG. 5D illustrates the completion of the removal operation on the waste ink tank 51 by the user after the release of the engagement between the engagement portions 53b and the engagement portions 50b.

Although the processing in steps S11 to S13 in FIG. 6 is normally performed in no time substantially, waste ink flowing through the suction tube 21 continuously flows to the flow channel member 23 and the waste ink tank 51 even after the suction pump 22 is stopped in step S13. As for this issue, the members restricting movement of the waste ink tank 51 in the removal direction provided as in the present exemplary embodiment allow the waste ink flowing out of the flow channel member 23 to fall in the waste ink take-in portion 54a. In other words, even if a time lag occurs in the processing time in steps S11 to S13 in FIG. 6, the positional relationship for waste ink to be taken into the waste ink tank 51 is maintained until the operation of the suction pump 22 and the flow of waste ink are stopped. This prevents waste ink from leaking to the outside of the waste ink tank 51 and the outside of the recording apparatus 50.

For the above-described configuration, the length L1 of the waste ink take-in portion 54a in the Y direction is designed to be greater than or equal to the length (distance) L2 from the engagement portions 53b to the engagement portions 50b (L1≥L2) in the installed state. Further, the direction (upward direction) to release the engagement between the engagement portions 50b and the engagement portions 53b is different from the removal direction (direction opposite to conveyance direction) of the waste ink tank 51 allows a temporary restriction of the operation of removing the waste ink tank 51 by the user.

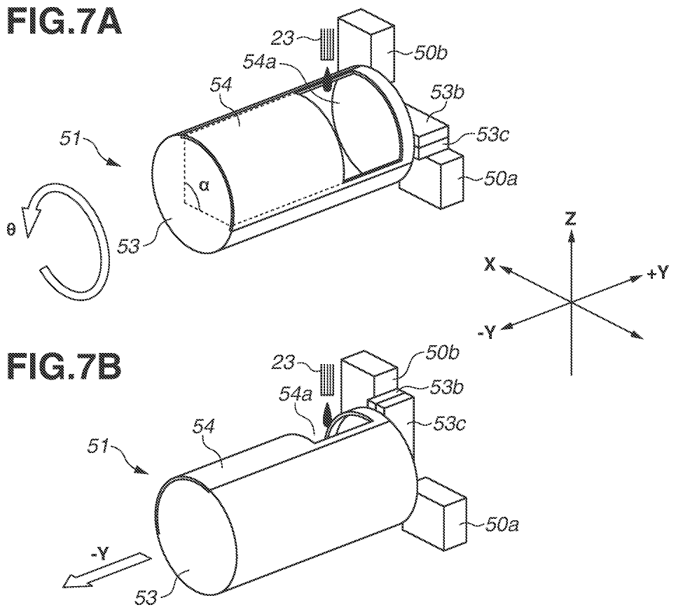

A second exemplary embodiment of the present disclosure will be described with reference to FIGS. 7A and 7B. FIGS. 7A and 7B are perspective views illustrating operation of removing the waste ink tank 51 according to the second exemplary embodiment. FIG. 7A illustrates the waste ink tank 51 installed in place, and FIG. 7B illustrates a temporary restriction. The waste ink tank 51 according to the second exemplary embodiment has a columnar shape, and an engagement portion 53b and a detected portion 53c are at one end part of the column in the axial direction.

The user rotates the waste ink tank 51 by a predetermined angle in the counterclockwise direction (θ direction) as one rotation direction around the axial direction of the waste ink tank 51 in the installed state illustrated in FIG. 7A. This rotation causes the engagement portion 50b and the engagement portion 53b to engage with each other as illustrated in FIG. 7B, which prevents further rotation. Thereafter, the user moves the waste ink tank 51 in the −Y direction parallel to the axial direction of the waste ink tank 51, completing the removal operation.

The flow channel member 23 and the opening of the waste ink take-in portion 54a face each other to receive waste ink flowing out of the flow channel member 23 in either the installed state illustrated in FIG. 7A or the restricted state illustrated in FIG. 7B. In other words, the central angle α of the fan shape in the side portion corresponding to the arc of the opening of the waste ink take-in portion 54a is greater than a predetermined rotation angle (about 90 degrees in the second exemplary embodiment) of the waste ink tank 51 rotated to change the state from the installed state to the restricted state by the user. This prevents waste ink from leaking to the outside of the waste ink tank 51 and the outside of the recording apparatus 50.

As described above, the removal direction from the installed state to the restricted state and the removal direction to release the restricted state different from each other reduces leakage of the waste ink.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-170871, filed Oct. 9, 2020, which is hereby incorporated by reference herein in its entirety.

What is claimed is:

1. A recording apparatus comprising:
a recovery unit configured to perform recovery operation to recover a recording head to eject liquid;
a retaining container configured to be removably installed in the recording apparatus and to retain liquid discharged from the recovery unit; and
a first portion configured to come in contact with a second portion on the retaining container,
wherein, to put the retaining container into a restricted state in which movement of the retaining container in a first direction is restricted, the first portion comes in contact with the second portion in a middle of removal of the retaining container in the first direction from an installed state in which the retaining container is installed in the recording apparatus.

2. The recording apparatus according to claim 1,
wherein the retaining container includes a take-in portion in which liquid discharged from the recovery unit is taken in, and
wherein a length of the take-in portion in the first direction is greater than a length from the second portion to the first portion in the first direction in the installed state.

3. The recording apparatus according to claim 1, wherein the retaining container in a second direction different from the first direction, the retaining container is released from the restricted state.

4. The recording apparatus according to claim 3, further comprising a conveyance unit configured to convey, in a conveyance direction, a recording medium on which recording is to be performed by the recording head,
wherein the first direction is a direction opposite to the conveyance direction.

5. The recording apparatus according to claim 3, wherein the second direction is in an upward gravitational direction.

6. The recording apparatus according to claim 1,
wherein, by moving the retaining container in a second direction different from the first direction, the retaining container is released from the restricted state, and
wherein the first direction is a rotation direction around the second direction.

7. The recording apparatus according to claim 6,
wherein the retaining container includes a take-in portion in which liquid discharged from the recovery unit is taken in, and
wherein a length of the take-in portion in the first direction is greater than a length from the second portion to the first portion in the first direction in the installed state.

8. The recording apparatus according to claim 1, further comprising a detection unit configured to detect the retaining container in the installed state.

9. The recording apparatus according to claim 8, wherein, in response to a detection of the retaining container not in the installed state by the detection unit, the recovery operation is stopped.

10. The recording apparatus according to claim 1,
wherein the retaining container includes a positioning surface that faces a center in a direction intersecting the first direction, and
wherein, to be positioned in the intersecting direction, the positioning surface of the retaining container comes in contact with a guide of the recording apparatus.

11. The recording apparatus according to claim 10, wherein the positioning surface is at both ends of the retaining container in the intersecting direction.

12. A retaining container removably installed in a recording apparatus, wherein the recording apparatus includes a recovery unit to perform recovery operation to recover a recording head to eject liquid, and the retaining container is to retain liquid discharged from the recovery unit, the retaining container comprising:
a second portion configured to come in contact with a first portion in the recording apparatus,
wherein, to put the retaining container into a restricted state in which movement of the retaining container in a first direction is restricted, the second portion and the first portion come in contact with each other in a middle of removal of the retaining container in the first direction from an installed state in which the retaining container is installed in the recording apparatus.

13. The retaining container according to claim 12, further comprising a take-in portion in which liquid discharged from the recovery unit is taken in,
wherein a length of the take-in portion in the first direction is greater than a length from the second portion to the first portion in the first direction in the installed state.

14. The retaining container according to claim 12, wherein, by moving the retaining container in a second direction different from the first direction, the retaining container is released from the restricted state.

15. The retaining container according to claim 14,
wherein the recording apparatus further includes a conveyance unit configured to convey, in a conveyance direction, a recording medium on which recording is to be performed by the recording head, and
wherein the first direction is a direction opposite to the conveyance direction.

16. The retaining container according to claim 14, wherein the second direction is in an upward gravitational direction.

17. The retaining container according to claim 12,
wherein, by moving the retaining container in a second direction different from the first direction, the retaining container is released from the restricted state, and
wherein the first direction is a rotation direction around the second direction.

18. The retaining container according to claim 17, further comprising a take-in portion in which liquid discharged from the recovery unit is taken in,
wherein a length of the take-in portion in the first direction is greater than a length from the second portion to the first portion in the first direction in the installed state.

19. The retaining container according to claim 12, further comprising a positioning surface that faces a center in a direction intersecting the first direction,
wherein, to be positioned in the intersecting direction, the positioning surface of the retaining container comes in contact with a guide of the recording apparatus.

20. The retaining container according to claim 19, wherein the positioning surface is at both ends of the retaining container in the intersecting direction.
